(19) United States
(12) Patent Application Publication
(10) Pub. No.: US 2008/0265774 A1
(43) Pub. Date: Oct. 30, 2008

(54) PLASMA DISPLAY PANEL AND ITS PRODUCTION PROCESS

(75) Inventors: Satoru WEBSTER, Chiyoda-ku (JP); Setsuro ITO, Chiyoda-ku (JP)

Correspondence Address: OBLON, SPIVAK, MCCLELLAND MAIER & NEUSTADT, P.C., 1940 DUKE STREET, ALEXANDRIA, VA, 22314, US

(73) Assignee: ASAHI GLASS COMPANY LIMITED, Tokyo (JP)

(21) Appl. No.: 11/950,433

(22) Filed: Dec. 5, 2007

Related U.S. Application Data
(63) Continuation of application No. PCT/JP07/66138, filed on Aug. 20, 2007.

(30) Foreign Application Priority Data
Aug. 21, 2006 (JP) 2006-224215
Dec. 1, 2006 (JP) 2006-325291

(51) Int. Cl. H01J 17/49; H01J 9/02

(52) U.S. Cl. 313/587; 445/24

(57) ABSTRACT

For a PDP, a panel having favorable discharge properties such a high discharge efficiency and a short discharge delay, being chemically stable and capable of electric power saving, is desired.

A plasma display panel comprising a front substrate and a rear substrate facing each other via a discharge space, discharge electrodes formed on at least one of the front substrate and the rear substrate, a dielectric layer covering the discharge electrodes, and a protective layer covering the dielectric layer, wherein the protective layer contains a Mayenite compound, and the secondary emission coefficients when Ne and Xe are used as excited ions at an accelerating voltage of 600 V, are respectively at least 0.05 at a secondary electron collector voltage at which secondary electrons can be sufficiently captured.

### TECHNICAL FIELD

The present invention relates to a plasma display panel.

### BACKGROUND ART

A plasma display panel (hereinafter referred to as PDP) has such a structure that one of two glass substrates facing each other with a discharge space in which a discharge gas is sealed, has pairs of display electrodes extending in the lateral direction arranged in the lengthwise direction, and the other has sustaining electrodes extending in the lengthwise direction arranged in the lateral direction, and at intersections of the pairs of display electrodes and the sustaining electrodes in the discharge space, matrix unit luminescence regions (discharge cells) are formed.

The operation principle of a PDP is to utilize a luminescence phenomenon accompanying the gas discharge. As its structure, it has barrier ribs between a transparent front substrate and a back substrate facing each other, and cells (space) are partitioned by the barrier ribs. Into the cells, a Penning gas mixture such as He and Xe or Ne and Xe with small visible luminescence and a high ultraviolet luminous efficiency is sealed to generate plasma discharge in the cells, which makes a phosphor layer on the inner wall of the cells emit light to form an image on the display screen.

In the PDP, at a position which faces the unit luminescence regions on a dielectric layer formed to cover the display electrodes and the sustaining electrodes, a magnesium oxide (MgO) film having a function to protect the dielectric layer and a function of secondary emission to the unit luminescence regions is formed. As a method of forming such a magnesium oxide film in a PDP production process, a deposition method and a screen printing method of forming a film by coating a dielectric layer with an ink having a magnesium oxide is powder mixed therewith have been known (e.g. Patent Document 1).

In a PDP having such a structure, secondary electrons are discharged from the surface of the MgO film by entrance of Penning gas ions into the MgO film. It has been known that in a PDP, a plasma state is formed triggered by the secondary electron current. The problem here is that the MgO film discharges no sufficient secondary electrons for plasma formation by the entrance of Xe ions, whereby it discharges sufficient secondary electrons by entrance of Ne ions (Non-Patent Document 1).

Further, MgO is a chemically unstable substance in the air, and accordingly it is difficult to obtain a PDP having favorable properties unless an activating treatment of carrying out heat treatment in vacuum is carried out.

Patent Document 1: JP-A-6-325696

Non-Patent Document 1: Kyoung Sup, Jihwa Lee, and Ki-Woong, J. Appl. Phys, 86, 4049 (1999)

### DISCLOSURE OF THE INVENTION

### Object to be Accomplished by the Invention

The object of the present invention is to solve the above problems and to provide a PDP for which Ne ions or Xe ions can be used as excited ions, which provides a favorable efficiency of ultraviolet luminescence from the sealed gas, which provides favorable discharge properties such as discharge efficiency and a short discharge delay, and which is chemically stable and is capable of electric power saving.

### Means to Accomplish the Object

The present invention provides a plasma display panel comprising a front substrate and a rear substrate facing each other via a discharge space, discharge electrodes formed on at least one of the front substrate and the rear substrate, a dielectric layer covering the discharge electrodes, and a protective layer covering the dielectric layer, wherein the protective layer contains a Mayenite compound, and the secondary emission coefficients when Ne and Xe are used as excited ions at an accelerating voltage of 600 V, are respectively at least 0.05 at a secondary electron collector voltage at which secondary electrons can be sufficiently captured.

Further, the present invention provides the above plasma display panel, wherein the secondary emission coefficient when Ne is used as excited ions is at least 0.05 at a secondary electron collector voltage at which secondary electrons can be sufficiently captured.

Further, the present invention provides the above plasma display panel, wherein the secondary emission coefficient when Xe is used as excited ions is at least 0.05 at a secondary electron collector voltage at which secondary electrons can be sufficiently captured.

Further, the present invention provides the above plasma display panel, wherein the Mayenite compound is 12CaO.7Al₂O₃ or 12SrO.7Al₂O₃.

Further, the present invention provides the above plasma display panel, wherein the Mayenite compound has a part of Al substituted by Si, Ge, B or Ga.

Further, the present invention provides the above plasma display panel, wherein the Mayenite compound has a part of constituting oxygen substituted by electron, and has an electron density of at least 1×10¹⁵ cm⁻³.

Further, the present invention provides the above plasma display panel, wherein the protective layer has a thin layer having a conductivity of at most 1.0×10⁻⁵ S/cm on the dielectric layer, and on a part of the thin layer, the Mayenite compound having an electron density of at least 1×10¹⁵ cm⁻³ is disposed.

Further, the present invention provides the above plasma display panel, wherein the thin layer is a layer containing at least one compound selected from the group consisting of MgO, SrO, CaO, SrCaO and a Mayenite compound.

Further, the present invention provides the above plasma display panel, wherein the content of the Mayenite compound is at least 5 vol % to the total volume of the materials forming the protective layer.

Further, the present invention provides a process for producing a plasma display panel comprising a front substrate and a rear substrate facing each other via a discharge space, discharge electrodes formed on at least one of the front substrate and the rear substrate, a dielectric layer covering the discharge electrodes, and a protective layer covering the dielectric layer, which comprises a step of forming a thin layer having an electrical conductivity of at most 1.0×10⁻⁵ S/cm on the dielectric layer, and disposing a Mayenite compound having an electron density of at least 1×10¹⁵ cm⁻³ on a part of the thin layer.

Still further, the present invention provides the above process for producing a plasma display panel, wherein the thin layer is a layer containing at least one compound selected from the group consisting of MgO, SrO, CaO, SrCaO and a Mayenite compound.

### EFFECTS OF THE INVENTION

The PDP comprising a protective layer containing a Mayenite compound of the present invention has favorable discharge properties such as a high ultraviolet luminous efficiency, a high discharge efficiency and a short discharge delay, and is chemically stable.

### BRIEF DESCRIPTION OF THE DRAWINGS

FIG. 1 is a cross section schematically illustrating a first embodiment of the present invention in which Mayenite particles are disposed on a protective layer of a PDP.

FIG. 2 is a cross section schematically illustrating a second embodiment of the present invention in which Mayenite particles are contained in a protective layer of a PDP.

FIG. 3 is a graph illustrating light absorption spectra of samples A and B, obtained by converting a diffuse reflection spectrum by Kubelka-Munk method.

FIG. 4 is a graph illustrating ESR signals of Sample A.

FIG. 5 is a view schematically illustrating a secondary emission coefficient measuring apparatus.

FIG. 6 is a graph illustrating the relation between the secondary emission coefficient (γ) of sample A and the collector voltage.

FIG. 7 is a graph illustrating the relation between the secondary emission coefficient (y) and the collector voltage when Ne or Xe is used as excited ions.

FIG. 8 is a diagram illustrating the dependence of the secondary emission coefficient on the excited ion energy measured with respect to C12A7 compounds at electron concentrations of 10²¹ cm⁻³ and 10¹⁹ cm⁻³.

FIG. 9 is a diagram illustrating discharge delay properties (statistical delay and formative delay properties) of a panel A having Mayenite particles supported on a protective layer and a panel B using only a MgO film as a protective layer.

### MEANINGS OF SYMBOLS

12: Thin layer
14: Mayenite compound particles
20: Protective layer
22: Base material
24: Particles of a Mayenite compound

### BEST MODE FOR CARRYING OUT THE INVENTION

A PDP usually has a front substrate and a rear substrate facing each other via a discharge space, discharge electrodes formed on at least one of the front substrate and the rear substrate, a dielectric layer covering the discharge electrodes, and a protective layer in the form of a thin film covering the dielectric layer.

In a conventional PDP, a MgO film is mainly used for the protective layer. In a PDP using a MgO film for the protective layer, MgO is irradiated with Ne ions as excited ions to discharge secondary electrons, which then forms a plasma state, and from neutral excited Xe atoms or Xe molecules present in the plasma, vacuum ultraviolet rays are emitted. Further, in the plasma, a Penning gas is present as ionized.

In the present invention, by the protective layer containing a Mayenite compound, not only Ne ions but also Xe ions can be used as excited ions, and also in a case where Xe ions are used, a high secondary emission coefficient is obtained, and the efficiency of ultraviolet luminescence from a PDP will improve.

Here, the secondary emission coefficient is measured by irradiating a target (a sample to be measured) disposed in a vacuum container with Ne ions or Xe ions by an ion gun, and collecting secondary electrons using a secondary electron collector disposed near the target.

The secondary electron collector voltage at which secondary electrons can be sufficiently captured in the present invention is not particularly limited so long as it is a voltage at which secondary electrons can be sufficiently captured and varies depending upon the material of the target. The number of secondary electrons which can be captured increases as the collector voltage increases, and the number of secondary electrons which can be captured is saturated by degrees along with the increase of the voltage. The secondary electron collector voltage at which secondary electrons can be sufficiently captured means a voltage at which the number of secondary electrons which can be captured is saturated. For example, in the case of an electrically conductive Mayenite compound, the secondary emission coefficient γ is substantially saturated at 70 V, and accordingly a value at 70 V may be regarded as the γ value.

In the present invention, a Mayenite compound means 12CaO.7Al₂O₃ (hereinafter sometimes referred to as C12A7) crystals and an analogue having a crystal structure similar to the C12A7 crystals. A Mayenite compound has a cage structure and includes oxygen ions in the cage. The Mayenite compound in the present invention includes an analogue having a part of or all cations or anions in the skeleton or the cage substituted, so long as the skeleton of the C12A7 crystal lattice and the cage structure formed by the skeleton are maintained. Specifically, the following compounds (1) to (4) may be mentioned as examples of the Mayenite compound, but the Mayenite compound is not limited thereto.

(1) Strontium aluminate Sr₁₂Al₁₄O₃₃ having a part of or all cations in the skeleton of the C12A7 compound substituted, and calcium strontium aluminate Ca₁₂₋ₓSrₓAl₁₄O₃₃ which is mixed crystals having a mixture ratio of Ca and Sr optionally changed.

(2) Ca₁₂Al₁₀Si₄O₃₅ which is a silicon-substituted Mayenite.

(3) One having free oxygen in the cage substituted by an anion such as OH⁻, F⁻, S²⁻ or Cl⁻, such as Ca₁₂Al₁₄O₃₂:2OH⁻ or Ca₁₂Al₁₄O₃₂:2F⁻.

(4) One having both cation and anion substituted, such as Wadalite Ca₁₂Al₁₀Si₄O₃₂:6Cl⁻.

The Mayenite compound of the present invention may have a part of Al contained in a Mayenite compound substituted by Si, Ge, Ga or B. Further, the Mayenite compound may contain at least one member selected from the group consisting of Si, Ge, Ga and B; at least one member selected from the group consisting of Li, Na and K; at least one member selected from the group consisting of Mg and Ba; at least one rare earth element selected from the group consisting of Ce, Pr, Nd, Sm, Eu, Gd, Tb, Dy, Ho, Er, Tm and Yb; or at least one transition metal element or typical metal element selected from the group consisting of Ti, V, Cr, Mn, Fe, Co, Ni and Cu.

In the present specification, an electrically conductive Mayenite compound means a compound having a part of or all free oxygen ions or anions in the cage of the above Mayenite compound substituted by electrons and thus having electrons included in the cage. The included electrons are loosely bound in the cage and can freely move in crystals thereby to impart electrical conductivity to the Mayenite compound. A C12A7 compound having all free oxygen substituted by electrons may sometimes be represented as [Ca₂₄Al₂₈O₆₄]⁴⁺ (4e⁻). In a case where an electrically conductive Mayenite compound is used in the present invention, it is preferred to use a Mayenite compound having an electron density of at least 1×10¹⁵ cm⁻³.

The conductivity of the electrically conductive Mayenite compound is preferably at least 1.0×10⁻⁴ S/cm, more preferably at least 1.0 S/cm, furthermore preferably at least 100 S/cm. The electron mobility of the C12A7 compound is approximately 0.1 S/cm⁻¹. Since the conductivity is usually a product of the mobility and the electron density, when the conductivity of the Mayenite compound is 1.0×10⁻⁴ S/cm, 1.0 S/cm and 100 S/cm, the electron density is 10¹⁵ cm⁻¹, 10¹⁹ cm⁻³ and 10²¹ cm⁻³, respectively. From the above, in a case where an electrically conductive Mayenite compound is used in the present invention, the electron density is preferably at least 1×10¹⁵ cm⁻³, more preferably at least 1×10¹⁹ cm⁻³, furthermore preferably at least 1×10²¹ cm⁻³.

In general, a compound having a low work function has high secondary emission performance. For example, the bulk of an electrically conductive Mayenite compound is cleft or ground in vacuum to obtain a clean surface, and the work function on that occasion is about 2 eV. The clean surface means no attachment of impurities such as a degenerated layer or an organic substance on the surface. Further, such a clean surface can be obtained also by holding a Mayenite compound in ultra-high vacuum at a temperature of approximately 650° C. or higher. Further, when a part of electrons in the cage on the outermost layer disappear by applying appropriate treatment to the surface of an electrically conductive Mayenite compound, the effective work function can be lowered to 1 eV or lower. The thickness of the surface modified layer is preferably at most 1 nm. If the thickness exceeds 1 nm, no effect of lowering the work function may be obtained.

In a case where an electrically conductive Mayenite is used in the present invention, the surface state of the Mayenite compound may be the clean surface, but preferred is the above-described surface modified layer, whereby an increase of the secondary emission properties can be expected since the work function is low. To impart the above-described surface modified layer to the electrically conductive Mayenite compound, for example, electrons in the cage may be substituted by O²⁻, F⁻, OH⁻ or Cl⁻. For example, in a case where they are substituted by O²⁻, heat treatment under an oxygen partial pressure P_{O2} by the Pa unit higher than the oxygen partial pressure represented by the mathematical formula 1, where T is the temperature:

P_{O2}=10⁵×exp [{7.9×10⁴/(T+273)}+14.4]

On the surface of the Mayenite compound used in the present invention, preferably no impurities such as an organic substance are attached, so as not to decrease the secondary emission properties.

The secondary emission coefficient γ of the protective layer containing the Mayenite compound of the present invention is, when Ne or Xe is used as excited ions at an accelerating voltage of 600 V, is at least 0.05, preferably at least 0.1. This is because by secondary electrons, Xe atoms become Xe ions, which emit ultraviolet rays, whereby the efficiency of ultraviolet luminescence from Xe will improve. The secondary emission coefficient γ is more preferably at least 0.2. This is because the efficiency of ultraviolet luminescence from Xe will further improve, whereby a PDP having favorable discharge properties such as a high discharge efficiency and a small discharge delay will be obtained.

The secondary emission coefficient γ when Ne is used as excited ions is at least 0.05, more preferably at least 0.2. Further, the secondary emission coefficient γ when Xe is used as excited ions is at least 0.05, more preferably at least 0.07.

The protective layer containing a Mayenite compound of the present invention provides favorable discharge properties of a PDP such as a discharge efficiency and a short discharge delay. The reason is considered to be because the Mayenite compound is excellent in electron emission properties such as having a high secondary emission coefficient γ, as described above.

The discharge delay means a time lag between application of the voltage and the beginning of the discharge, and comprises a formative delay which is a time lag between beginning of the discharge and the time when an electric current is actually observed, and a statistical delay which is dispersion of beginning of the discharge.

Particularly, the statistical delay relates to the degree of formation of initial electrons, and accordingly a material excellent in electron emission properties is used, the discharge delay can be reduced. Accordingly, a Mayenite compound having a high secondary emission coefficient γ is considered to be capable of reducing the discharge delay. The discharge delay in a PDP can be measured, for example, by measuring luminescence of discharge plasma by application of a voltage.

An AC PDP of which the impressed voltage for discharge is an alternating current, enlargement of the display size and high definition are simultaneously required as a large display device. The decrease in the luminous efficiency and the increase in the discharge delay become problematic along with miniaturization of discharge cells. To improve the luminous efficiency, as mentioned above, an increase of the Xe concentration of the discharge gas is effective. Since a Mayenite compound has a high secondary emission coefficient γ also to Xe, a Penning gas having a high Xe gas concentration can be used as compared with a conventional PDP.

Further, the discharge delay drastically increases when the pixels of a PDP are miniaturized, and accordingly preparation of a higher definition PDP will be difficult. However, when a protective layer containing a Mayenite compound is used for a PDP, the discharge delay will be reduced, and it is possible to miniaturize pixels.

The Mayenite compound to be used for the PDP of the present invention can be prepared, for example, as follows. However, another preparation method may be employed, or preparation conditions may be changed.

CaO or SrO and Al₂O₃ in a molar ratio of CaO or SrO to Al₂O₃ of from 11.8:7.2 to 12.2:6.8 are blended or mixed, and the resulting material is heated to 1,200 to 1,350° C. in the air to prepare a Mayenite compound by solid phase reaction. The compound is crushed to obtain a powder of the Mayenite compound, which is pelletized by pressure forming and heated again to 1,200 to 1,350° C. and held to prepare a sintered product. The sintered product together with a powder or fragments of at least one member selected from the group consisting of carbon, metal titanium, metal calcium and metal aluminum is put in a container with a lid, held at 600 to 1,350° C. in a state where the interior of the container is maintainer under low oxygen partial pressure and then cooled to obtain an electrically conductive Mayenite compound.

The embodiment of the protective layer of the present invention will be described below.

A first embodiment of the present invention is as shown in FIG. 1. In FIG. 1, Mayenite compound particles 14 are disposed on at least part of a thin layer 12 of e.g. MgO. The Mayenite compound particles 14 may comprise an electrically conductive Mayenite compound having an electron density of at least 1×10¹⁵ cm⁻³.

In FIG. 1, the thin layer 12 is not particularly limited so long as it is electrically conductive, but in is view of a high secondary emission efficiency, preferred is a thin film containing at least one compound selected from the group consisting of MgO, SrO, CaO, SrCaO and a Mayenite compound. The thin layer 12 may comprise two or more layers.

The thickness of such a protective layer (the total thickness of the thin layer and the Mayenite compound particles) is not particularly limited. For example, it may be equal to the thickness of a protective layer comprising MgO in a conventional PDP. It may, for example, be from 0.01 to 50 μm, and it is preferably from 0.02 to 20 μm, more preferably from 0.05 to 10 μm.

As described above, in a case where the obtained Mayenite compound is applied to the thin layer 12 by e.g. spin coating, it is required to form the Mayenite compound into a powder. On that occasion, compressive force, shear force and frictional force are mechanically applied to the material to crush it by using a hammer, a roller, a ball or the like of e.g. a metal or a ceramic. On that occasion, by use of a planetary mill using tungsten carbide balls, it is possible to obtain coarse particles having a particle size of at most 50 μm without inclusion of foreign substances in the coarse particles of the Mayenite compound.

The Mayenite compound thus obtained may be further crushed into fine particle having an average particle size of at most 20 μm by using a ball mill or a jet mill. It is possible to mix such particles of at most 20 μm with an organic solvent or a vehicle to prepare a slurry or a paste, but by mixing a Mayenite compound coarsely crushed to at most 50 μm with an organic solvent, followed by crushing with beads, a dispersion solution having a finer Mayenite compound powder having a size as calculated as circles of at most 5 μm dispersed can be prepared. For crushing with beads, for example, zirconium oxide beads may be used.

In a case where an alcohol or an ether is used as a solvent at the time of crushing, if it is a compound having one or two carbon atoms and having a hydroxyl group, the electrically conductive Mayenite compound may be reacted therewith and decomposed. Accordingly, when such a solvent is used, preferred is one having at least 3 carbon atoms. A compound having at least 3 carbon atoms and a hydroxyl group, an amide compound or an organic solvent having a sulfur compound dissolved may, for example, be 1-propanol or 2-propanol, 1-butanol or 2-butanol, ethylene glycol monomethyl ether, ethylene glycol monoethyl ether, ethylene glycol monobutyl ether, ethylene glycol isopropyl ether, propylene glycol monomethyl ether, propylene glycol monoethyl ether, propylene glycol isopropyl ether, pentyl alcohol, 1-hexanol, 1-octanol, 1-pentanol, tert-pentyl alcohol, N-methylformamide, N-methylpyrrolidone or dimethyl sulfoxide. Such solvents are used alone or as mixed, whereby crushing will easily be carried out.

To form a Mayenite compound on a protective layer to form the PDP of the present invention, a powder of a Mayenite compound is mixed with a solvent to prepare a slurry or a paste, which is applied to the protective layer and fired. The coating method may, for example, be spray coating, die coating, roll coating, dip coating, curtain coating, spin coating or gravure coating, and spin coating and spray coating are particularly preferred with a view to operating the powder density more easily and accurately. As preferred firing conditions for the coating film, the temperature is preferably from 200 to 800° C. at which organic substances in the components of the slurry will be decomposed, and the Mayenite compound will be sufficiently fixed on the thin layer. In a case where an electrically conductive Mayenite compound is used as the Mayenite compound, the temperature is preferably such a temperature that the oxidative effect of the electrically conductive Mayenite compound will not be accelerated. In such a case, it is preferably from 200 to 600° C. Further, the firing time is preferably about 10 minutes.

One example of a method for preparing a slurry to be used for formation of the Mayenite compound on the protective layer for formation of the PDP of the present invention, is a method of dehydrating the above solvent having a low moisture content, mixing from 0.01 to 50 is mass % of Mayenite compound coarse particles of at most 50 μm with from 50 to 99.99 mass % of the solvent, and mixing zirconium oxide beads in a weight from 2 to 5 times the solvent as crushing mills with the above mixture to carry out crushing with beads, thereby to disperse the electrically conductive Mayenite compound in the solvent. On that occasion, it is preferred to use zirconia oxide beads having a size of from 0.01 to 0.5 mm in diameter, whereby a slurry containing an electrically conductive Mayenite compound powder having an average particle size of at most 5 μm can be obtained.

In the slurry of the present invention, the average particle size of the particles of the Mayenite compound to be used for the PDP is preferably as small as possible, but it is difficult to obtain a powder having an average particle size less than 0.002 μm. Further, such a size is about the same as the size of the unit cell of the Mayenite compound, and accordingly, when an electrically conductive Mayenite compound is used as the Mayenite compound, if the particle size is too small, the compound may not keep electrical conductivity. Therefore, the average particle size is preferably at least 0.002 μm. Further, if the average particle size of the powder exceeds 5 μm, no sufficient effect as an electron emitter will be obtained. In a case where the powder is used for a PDP, the average particle size of the Mayenite compound powder is preferably at most 5 μm, considering downsizing of the device and electric power saving. The average particle size of the electrically conductive Mayenite compound can be determined by a particle size distribution measuring apparatus by means of laser diffraction scattering method (light scattering method).

The electron emission efficiency depends on the particle size of the Mayenite compound particles on the protective layer and their density per unit area. In order to obtain a high secondary emission efficiency, the density of the Mayenite compound particles on the protective layer per unit area of the protective layer is preferably at least 0.001/R² (particle/μm²) and at most 0.5/R² (particle/μm²) to the size R (μm) of the cross section of the particles as calculated as circles. The size as calculated as circles is defined as a value double the square root of a value obtained by dividing the cross sectional area (area of the cross section when a powder is cut at a plane in parallel with a substrate) measured by a known method utilizing image analysis by the number π. However, the average particle size may be determined by a particle size distribution measuring apparatus by means of light scattering method, which is regarded as the size R as calculated as circles.

The standard deviation σ of the particle size distribution of particles which contribute to electron emission is preferably as small as possible. This is because even when a powder is disposed at an optimum distribution concentration relative to the average of the particle sizes, particles having particle sizes larger than the average have short distances with adjacent particles, and accordingly the electric field concentration effects are offset by each other and decrease, whereby no electron emission may occur. Further, particles having different particle sizes strictly have different electric field concentration effects, and accordingly, the electron emission may occur only from particles having high electric field concentration effects, whereby the total emission current of the entire PDP may decrease. Accordingly, σ of the particle size distribution is preferably at most 3 R, more preferably at most 2 R, furthermore preferably at most 1.5 R to the size R as calculated as circles.

When the unit of the size R as calculated as circles is represented by μm, the density of the particles which contribute to electron emission in the PDP of the present invention is preferably at least 0.001/R² particle and at most 0.5/R² particle per 1 μm² of the substrate surface. If it is less than 0.001/R² particle, the density of the particles which contribute to electron emission is too low, and the electron emission amount obtained as a device tends to be small. On the other hand, if it exceeds 0.5/R² particle, the electric field concentration effects may be offset since the distance between particles is small, whereby the number of electrons emitted from particles will decrease. It is more preferably at least 0.005/R² particle and at most 0.1/R² particle, more preferably at least 0.01/R² particle and at most 0.05/R² particle.

This means, for example, when a PDP is prepared using particles having a size R as calculated as circles of 0.5 μm, the particle density is preferably at least 0.004 particle/μm² and at most 2.0 particles/μm², more preferably at least 0.02 particle/μm² and at most 0.4 particle/μm², most preferably at least 0.04 particle/μm² and at most 0.2 particle/μm².

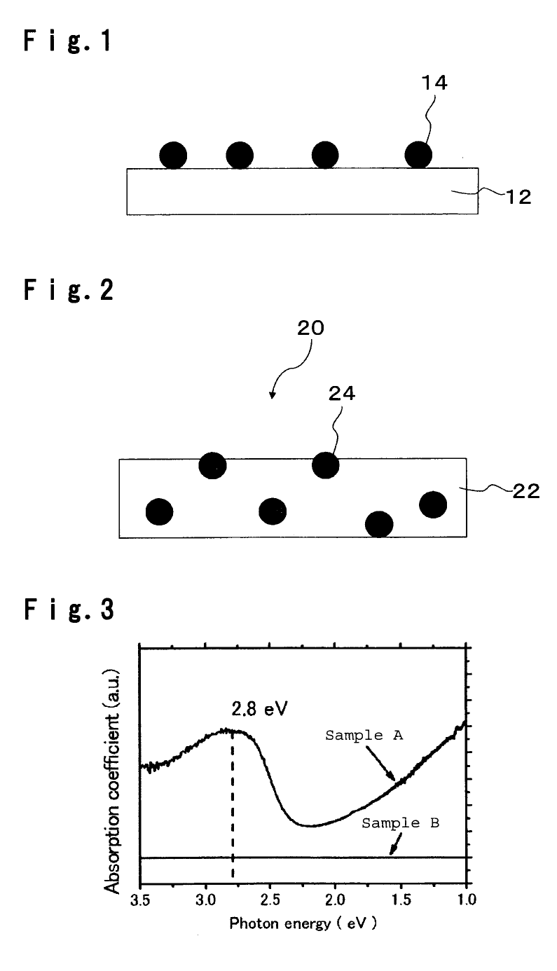

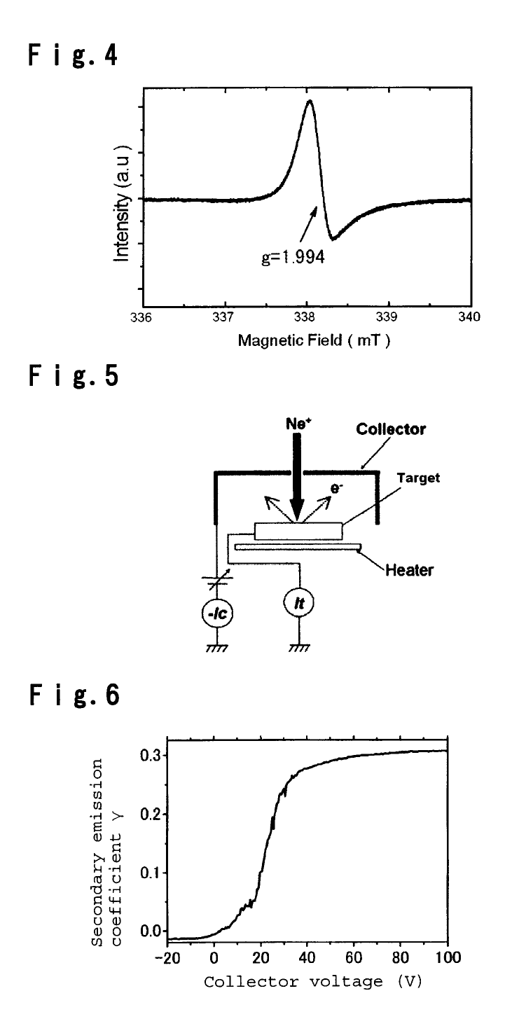

A second embodiment of the present invention resides in a protective layer 22 as shown in FIG. 2, having Mayenite compound particles 24 contained in the protective layer 22 comprising e.g. MgO as a base material. The Mayenite compound has high sputtering resistance to Ne ions as compared with MgO and has secondary emission function equal to MgO, and accordingly it is possible to form a protective layer made of only a Mayenite compound. Further, the protective layer may be formed by a mixture of a Mayenite compound, MgO, SrO, CaO and SrCaO. The Mayenite compound particles 24 may comprise an electrically conductive Mayenite compound having an electron density of at least 1×10¹⁵ cm⁻³.

The content of the Mayenite compound in the total volume of materials forming the protective layer is preferably at least 5 vol %, more preferably at least 10 vol %. Such a protective layer, which has high plasma resistance and is hardly plasma-etched, has high performance to protect the discharge electrodes and the dielectric layer in a PDP. The content of the electrically conductive Mayenite compound is preferably less than 25% to the total volume of materials forming the protective layer, from the viewpoint of electrification properties.

The Mayenite compound has high sputtering resistance to Ne ions as compared with MgO and has secondary emission function equal to MgO, and accordingly it is possible to form a protective layer made of only a Mayenite compound.

As a material other than the Mayenite compound constituting the protective layer, a metal oxide may be used. It is preferred to use an alkaline earth metal oxide, which has favorable electrification properties, whereby a low discharge voltage is obtained. More preferably, MgO can be used. Further, the protective layer may comprise two or more layers. Since the secondary emission coefficient γ when Xe is used as excited ions is high, the surface layer of the protective layer preferably contains a Mayenite compound.

The thickness of the protective layer (the total thickness of all the layers in the case of two or more layers) containing the Mayenite compound is not particularly limited. For example, the thickness of the protective layer may be about the same as the protective layer comprising MgO of a conventional PDP. It may, for example, be from 0.01 to 50 μm, and it is preferably from 0.02 to 20 μm, more preferably from 0.05 to 5 μm. In the PDP of the present invention, the thickness of the protective layer is the average thickness measured by a feeler type surface roughness meter.

For formation of the protective layer containing a Mayenite compound, various methods such as a deposition method and a screen printing method comprising coating a dielectric layer with an ink containing a powder of a Mayenite compound prepared by a method similar to formation of an ink containing an electrically conductive Mayenite compound as described above, may be used. As the vapor deposition method, a physical vapor deposition method (PVD) may, for example, be a vacuum deposition method, an electron beam deposition method, an ion plating method, an ion beam deposition method or a sputtering method. The sputtering method may, for example, be a DC sputtering method, an RF sputtering method, a magnetron sputtering method, an ECR sputtering method or an ion beam sputtering method (laser ablation method). Further, a chemical vapor deposition method (CVD) may, for example, be thermal CVD, plasma CVD or photo CVD. It is possible to form two layers by binary deposition or by depositing MgO or the like first and then depositing a Mayenite compound. Among them, the sputtering method and the ion plating method are preferred since the film thickness can be precisely controlled, and a transparent film can be formed. Further, an electron beam deposition method and CVD are preferred with a view to obtaining transparent and high quality crystals.

Further, for the protective layer of the present invention, it is possible to use an amorphous material containing Ca or Sr and Al in the same compositional ratio as the Mayenite compound. A part of Al contained in the amorphous material may be substituted by the same number of atoms of Si, Ge or Ga.

### EXAMPLES

Now, the present invention will be described in further detail with reference to Examples and Comparative Examples. However, the following Examples are only to more definitely describe the present invention, and the present invention is by no means restricted to the following Examples.

### Example 1

Calcium carbonate and aluminum oxide were mixed in a molar ratio of 12:7 and held in the air at 1,300° C. for 6 hours to prepare a 12CaO.7Al₂O₃ compound (hereinafter referred to as a C12A7 compound). The powder was formed into a molded product by a uniaxial pressing machine, and the molded product was held in the air at 1,350° C. for 3 hours to prepare a sintered product having a sintered density exceeding 99%. This sintered product was a white insulant showing no electrical conductivity (hereinafter referred to as sample B).

The sintered product together with metal aluminum was put in an alumina container with a lid and heated to 1,300° C. in a vacuum furnace and held for 10 hours and then slowly cooled to room temperature. The obtained heat treated product was black brown and confirmed to have a peak of a Mayenite structure as measured by X-ray diffraction. Further, it was found from a light absorption spectrum as measured by U3500 manufactured by Hitachi, Ltd. that it has an electron density of 1.4×10²¹/cm³ and a conductivity of 120 S/cm by van der Pauw method. The results are shown in Table 3. Further, the electron spin resonance (hereinafter referred to as ESR) signal of the obtained heat treated product was measured by JES-TE300 manufactured by JEOL Ltd. and as a result, the signal was asymmetric with a g value of 1.994 characteristic of an electrically conductive Mayenite compound having a high electron concentration exceeding 10²¹/cm³. Therefore, it was confirmed that an electrically conductive Mayenite compound was obtained (hereinafter referred to as sample A).

An apparatus for measuring the secondary emission coefficient in the present Example is schematically shown in FIG. 5. A target (sample to be measured) disposed in a vacuum container is irradiated with Ne⁺ ions by an ion gun, and secondary electrons are collected by an electrode disposed near the target.

The surface of sample A was ground by diamond abrasive and formed into a size of 15×15×4 mm, and placed as a target in a secondary emission properties measuring apparatus. Activating treatment which is annealing treatment in a vacuum container, which is applied to a usual MgO film, was omitted. The degree of vacuum in the apparatus was set at about 10⁻⁵ Pa, and Ne⁺ ions were applied at an accelerating voltage of 600 V, whereupon secondary emission properties as shown in FIG. 6 were obtained. At a collector voltage of approximately 70 V or more, the γ value was saturated, which indicates all emitted secondary electrons were collected. As shown in FIG. 6, the secondary emission coefficient γ was 0.3 at a collector voltage of 70 V.

### Example 2

A bulk prepared in the same manner as in preparation of sample A in Example 1, was crushed in a mortar to prepare a powder (hereinafter referred to as powder A). The particle size distribution of powder A was measured by means of laser diffraction scattering method using SALD2100 manufactured by Shimadzu Corporation and as a result, the average particle size was 5 μm. Powder A was supported on an electrically conductive tape, and measurement was carried out in the same manner as in Example 1 without carrying out annealing treatment and as a result, the secondary emission coefficient γ was 0.22.

### Example 3

Calcium carbonate and aluminum oxide were mixed in a molar ratio of 12:7 and held in the air at 1,300° C. for 6 hours to prepare a C12A7 compound. The powder was formed into a molded product by a uniaxial pressing machine, and the molded product was held in the air at 1,350° C. for 3 hours to prepare a sintered product having a sintered density exceeding 99%. The sintered product was a white insulant showing no electrical conductivity. The sintered product was put in a carbon crucible with a lid, put in a tubular furnace through which nitrogen flowed, held at 1,300° C. for 3 hours and then cooled to room temperature. The obtained compound was green. The compound was subjected to measurement of X-ray diffraction, a light scattering reflection spectrum and ESR and confirmed to be an electrically conductive C12A7 compound having an electron concentration of about 10²⁰/cm³ (hereinafter referred to as sample C).

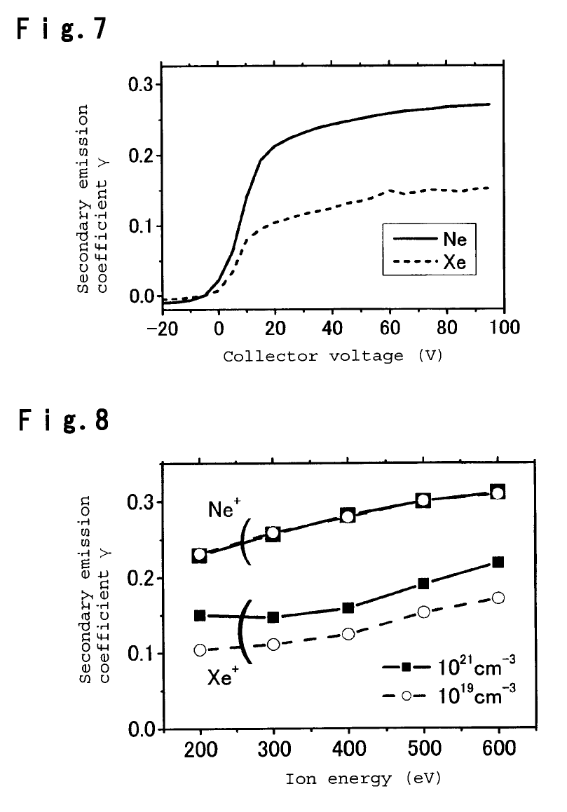

With respect to sample C, secondary emission properties were measured in the same manner as in Example 1 except that Ne or Xe was used as excited ions and as a result, properties as shown in FIG. 7 were obtained. As shown in Fig., it was found that an electrically conductive Mayenite compound has a high secondary emission coefficient not only to Ne ions but also Xe ions.

As mentioned above, as shown in Table 1, it was found that favorable secondary emission properties are obtained without activating treatment from a bulk or a powder of an electrically conductive Mayenite compound. The value γ shown in Table is a value of secondary emission properties at a collector voltage of 70 V.

### Example 4

A powder mixture of calcium carbonate and aluminum oxide were put in a platinum crucible and held in an electric furnace at 1,650° C. for 15 minutes, and quenched by a twin roller method to prepare C12A7 glass having a thickness of about 0.5 mm. The glass was crushed and put in a carbon crucible with a lid, heated to 1,650° C. at a heating rate of 400° C./hr and held in an atmosphere under an oxygen partial pressure of 10⁻¹⁵ Pa by absorption of oxygen by carbon for about 3 hours, and then slowly cooled to room temperature at a temperature-lowering rate of 400° C./hr. The obtained solidified product was a black dense solid (hereinafter referred to as sample D). Further, the powder was green. The solidified product was a Mayenite compound as confirmed by X-ray diffraction pattern. The electron concentration was about 10¹⁹/cm³ as determined by light scattering reflection measurement.

With respect to samples A and D, secondary emission properties were measured in the same manner as in Example 1 except that Ne⁺ or Xe⁺ was used as excited ions and that the ion accelerating voltage was changed within a range of from 200 to 600 eV and as a result, the ion accelerating voltage and γ are in the relation as shown in FIG. 8. As shown in FIG. 8, the electrically conductive Mayenite compound was found to show favorable secondary emission properties by not only Ne excitation but also Xe excitation. Further, in a case where the electron concentration of the electrically conductive Mayenite compound was about 10²¹/cm³, a higher secondary emission coefficient by Xe excitation was obtained as compared with the case of about 10¹⁹/cm³.

As described above, the secondary emission coefficient of usual MgO by Xe irradiation is less than 0.01, but the secondary emission coefficient of an electrically conductive Mayenite compound by Xe irradiation is at least 0.1. This figure is large by one figure or more as compared with MgO, and accordingly it was found that when an electrically conductive Mayenite compound is used as a protective layer, a plasma display panel with a low breakdown voltage can be prepared as compared with a case where a MgO film alone is used as a protective layer, whereby the driving method and the circuit can be simplified. Further, it was found that a low consumption plasma display panel can be prepared by increasing the Xe concentration in the discharge gas thereby to increase the luminous efficiency, without increasing the breakdown voltage.

### Example 5

Sample A together with 2-propanol and zirconia oxide beads with a diameter of 0.1 mm was put in a crushing container. The mass ratio was such that sample A:2-propanol:zirconia oxide beads=1:9:75. The crushing container was held at a speed of revolutions of 600 revolutions/hour for 48 hours, and the content was subjected to filtration to prepare a slurry containing an electrically conductive C12A7 compound. Further, using a centrifugal settler, the concentration in the slurry was adjusted to prepare a slurry containing 0.3 mass % of the electrically conductive C12A7 compound (hereinafter referred to as slurry A). The average particle size of the electrically conductive C12A7 compound in slurry A was measured by using a particle size distribution measuring apparatus (UPA150 manufactured by Microtrac) and as a result, it was 800 nm. Then, a MgO film was deposited on a front plate equipped with a glass substrate, discharge electrodes and a dielectric layer, and particles of sample A were deposited on the MgO film by using slurry A by a spin coating method (hereinafter referred to as panel A). The surface of panel A was observed by an optical microscope to count the number (number density) of particles per unit area and as a result, the number density of particles was about 3.0 particles/μm².

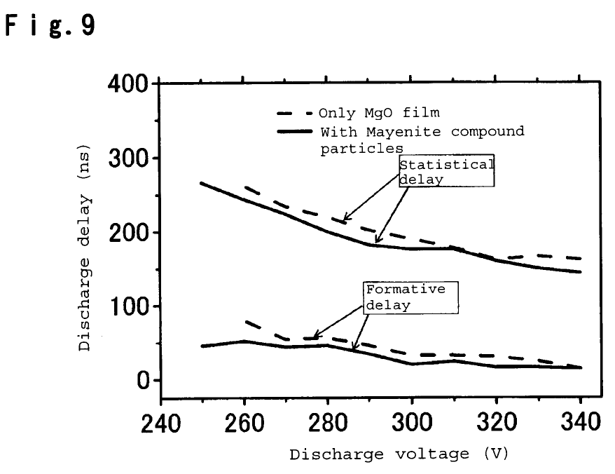

Panel A was held in a vacuum chamber, the interior of the vacuum chamber was maintained in an atmosphere of 20% Xe/80% Ne, and then a voltage was applied to the discharge electrodes for discharge. With respect to panel A, the discharge delay properties at a discharge voltage of 260 V were measured by a photo diode and as a result, as shown in FIG. 9, the statistical delay was 240 ns and the formative delay was 50 ns.

### COMPARATIVE EXAMPLE 1

The same measurement as in Example 1 was carried out except that an MgO film prepared on a glass substrate provided with an indium oxide (ITO) film was used as the target instead of sample A, but no significant γ value was obtained. Therefore, it was found that a MgO film which is usually used as a protective film, once left to stand and exposed to the air, quickly deteriorates to loose secondary emission properties, whereas an electrically conductive Mayenite compound provides favorable secondary emission properties even after exposed to the air.

### COMPARATIVE EXAMPLE 2

The same measurement as in Comparative Example 1 was carried out except that the sample was held in vacuum at 350° C. for 3 hours before measurement of the secondary emission coefficient and as a result, the secondary emission coefficient γ was 0.3.

### COMPARATIVE EXAMPLE 3

A discharge test was carried out in the same manner as in Example 5 by using the same panel (hereinafter referred to as panel B) as panel A except that no Mayenite compound was applied. With respect to panel B, the discharge delay properties at a discharge voltage of 260 V were measured by a photo diode and as a result, as shown in FIG. 9, the statistical delay was 260 ns and the formative delay was 80 ns. As shown in FIG. 9, it was found that the formative delay and the statistical delay of panel A were small as compared with panel B. As described above, it was found that the discharge delay of a PDP panel was decreased when a Mayenite compound is supported on a protective film as compared with a case where no Mayenite compound is present.

The results in Examples 1 and 2 and Comparative Examples 1 and 2 are shown in Table 1.

TABLE 1

| | | | γ value (Ne⁺ |
|---|---|---|---|
| | Measurement | Heat treatment in | accelerating |
| | sample | vacuum/activation | voltage: 600 V) |
| Ex. 1 | Sample A (bulk | Nil | 0.3 |
| | electrically | | |
| | conductive | | |
| | C12A7 compound) | | |
| Ex. 2 | Powder A | Nil | 0.22 |
| Comp. | MgO thin film | Nil | No significant |
| Ex. 1 | | | value obtained |
| Comp. | MgO thin film | 350° C. 3 hours | 0.3 |
| Ex. 2 | | | |

### INDUSTRIAL APPLICABILITY

According to the present invention, by disposing particles of an electrically conductive Mayenite compound on a protective layer, by a protective layer containing a Mayenite compound, or by a protective layer containing particles of an electrically conductive Mayenite compound, a PDP providing a high secondary emission coefficient by not only Ne ions but also Xe ions and having favorable discharge properties can be obtained, whereby electric power saving of a PDP is realized.

The entire disclosures of Japanese Patent Application No. 2006-224215 filed on Aug. 21, 2006 and Japanese Patent Application No. 2006-325291 filed on Dec. 1, 2006 including specifications, claims, drawings and summaries are incorporated herein by reference in their entireties.

What is claimed is:

1. A plasma display panel comprising a front substrate and a rear substrate facing each other via a discharge space, discharge electrodes formed on at least one of the front substrate and the rear substrate, a dielectric layer covering the discharge electrodes, and a protective layer covering the dielectric layer, wherein the protective layer contains a Mayenite compound, and the secondary emission coefficients when Ne and Xe are used as excited ions at an accelerating voltage of 600 V, are respectively at least 0.05 at a secondary electron collector voltage at which secondary electrons can be sufficiently captured.

2. The plasma display panel according to claim 1, is wherein the secondary emission coefficient when Ne is used as excited ions is at least 0.05 at a secondary electron collector voltage at which secondary electrons can be sufficiently captured.

3. The plasma display panel according to claim 1, wherein the secondary emission coefficient when Xe is used as excited ions is at least 0.05 at a secondary electron collector voltage at which secondary electrons can be sufficiently captured.

4. The plasma display panel according to claim 1, wherein the Mayenite compound is 12CaO.7Al₂O₃ or 12SrO.7Al₂O₃.

5. The plasma display panel according to claim 4, wherein the Mayenite compound has a part of Al substituted by Si, Ge, B or Ga.

6. The plasma display panel according to claim 1, wherein the Mayenite compound has a part of constituting oxygen substituted by electron, and has an electron density of at least 1×10¹⁵ cm⁻³.

7. The plasma display panel according to claim 1, wherein the protective layer has a thin layer having a conductivity of at most 1.0×10⁻⁵ S/cm on the dielectric layer, and on a part of the thin layer, the Mayenite compound having an electron density of at least 1.0×10⁻⁵ cm⁻³ is disposed.

8. The plasma display panel according to claim 1, wherein the thin layer is a layer containing at least one compound selected from the group consisting of MgO, SrO, CaO, SrCaO and a Mayenite compound.

9. The plasma display panel according to claim 1, wherein the content of the Mayenite compound is at least 5 vol % to the total volume of the materials forming the protective layer.

10. A process for producing a plasma display panel comprising a front substrate and a rear substrate facing each other via a discharge space, discharge electrodes formed on at least one of the front substrate and the rear substrate, a dielectric layer covering the discharge electrodes, and a protective layer covering the dielectric layer, which comprises a step of forming a thin layer having an electrical conductivity of at most 1.0×10⁻⁵ S/cm on the dielectric layer, and disposing a Mayenite compound having an electron density of at least 1×10¹⁵ cm⁻¹ on a part of the thin layer.

11. The process for producing a plasma display panel according to claim 10, wherein the thin layer is a layer containing at least one compound selected from the group consisting of MgO, SrO, CaO, SrCaO and a Mayenite compound.
